(19) United States
(12) Patent Application Publication
(10) Pub. No.: US 2011/0145485 A1
(43) Pub. Date: Jun. 16, 2011

(54) METHOD FOR MANAGING ADDRESS MAPPING TABLE AND A MEMORY DEVICE USING THE METHOD

(75) Inventors: Jin-Young Chun, Seoul (KR); Jaeyong Jeong, Yongin-si (KR)

(73) Assignee: SAMSUNG ELECTRONICS CO., LTD., Suwon-si (KR)

(21) Appl. No.: 12/946,893

(22) Filed: Nov. 16, 2010

(30) Foreign Application Priority Data
Dec. 11, 2009 (KR) 10-2009-0123446

(51) Int. Cl. G06F 12/10; G06F 12/00; G06F 12/02

(52) U.S. Cl. 711/103; 711/207; 711/E12.001; 711/E12.008; 711/E12.059

(57) ABSTRACT

An address mapping table includes arrays each being allocated to a logical address and in which a physical address mapping the logical address is stored. In the case where the physical address mapped to the logical address is changed, a value of a difference between a pre-changed physical address and a physical address to be changed is stored in the address mapping table. When the logical address is mapped to the physical address, the mapped physical address is calculated by adding up the logical address and values stored in the arrays allocated to the logical address. The address mapping table is managed to decrease the number of erase counts of a memory device in which the address mapping table is stored.

### CROSS-REFERENCE TO RELATED APPLICATIONS

A claim of priority under 35 U.S.C. §119 is made to Korean Patent Application No. 10-2009-0123446, filed on Dec. 11, 2009, the entirety of which is hereby incorporated by reference.

### BACKGROUND

The inventive concepts described herein generally relate to memory devices and, more particularly, to methods for managing an address mapping table of a memory device and to semiconductor devices which manage an address mapping table of a memory device.

Nonvolatile memory devices, which retain stored data in the absence of supplied power, generally include various types of memory cell transistors. Examples of nonvolatile memory devices include flash memory devices, variable resistance memory devices and the like.

Flash memory devices are generally classified as either NOR flash memory devices or NAND flash memory devices according to a memory cell array configuration. A NOR flash memory device includes memory cell transistors which are independently connected to bitlines and wordlines. Therefore, the NOR flash memory device exhibits relatively superior random access time characteristics. A NAND flash memory device includes a plurality of memory cell transistors connected in series, which is called a cell string structure, and requires only one bitline contact per cell string. Therefore, the NAND flash memory device is relatively superior in terms of integration density.

A flash memory user accesses a flash memory via an application program, a file system, and a memory controller to manage data. Since the flash memory cannot perform a data overwrite operation, the memory controller performs an erase operation in advance prior to a program operation. In addition, each memory cell of a flash memory has a limited lifetime in performing a write or erase operation. Therefore, the memory controller adopts a wear-leveling scheme in which the memory cells are uniformly utilized in across cell regions of the flash memory.

When accessing the flash memory device, the file system provides a logical address to the memory controller. The memory controller translates the logical address provided from the file system into a physical address of the flash memory. The memory controller manages address translation data for translating a logical address into a physical address. The address translation data is generally referred to as an address mapping table. When internally adopting a wear-leveling scheme, the flash memory may manage the address mapping table such that a memory cell address requested to the flash memory is mapped to a practically operating memory cell.

### SUMMARY

The present disclosure provides a method for managing an address mapping table of a nonvolatile memory device. According to some example embodiments of the inventive concepts, the method includes determining when a translated physical address mapped to a physical address has changed, and, when the translated physical address mapped to the physical address has been determined to change, storing a shift amount of an address to be shifted based on a pre-changed translated physical address mapped to the physical address in the address mapping table. The method further includes mapping the changed translated physical address to the physical address.

The present disclosure also provides a memory device. According to some example embodiments of the inventive concepts, the memory device includes a first memory cell array configured to store data, a wear-leveling control logic configured to manage a wear level operation, a second memory cell array configured to store an address mapping table, and a memory control logic. The memory control logic is configured to store a shift amount of an address to be shifted based on a pre-changed translated physical address mapped to a physical address in the address mapping table when a translated physical address mapped to a physical address of the first memory cell array is changed, and configured to map the physical address to the changed translated physical address with reference to the address mapping table.

### BRIEF DESCRIPTION OF THE DRAWINGS

The inventive concepts will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the inventive concepts.

FIG. 1 illustrates a method for managing an address mapping table according to an exemplary embodiment of the inventive concepts.

FIG. 2 illustrates an address translation of a nonvolatile memory device according to an embodiment of the inventive concepts.

FIG. 3 is a block diagram of a nonvolatile memory device according to an embodiment of the inventive concepts.

FIGS. 4A and 4B illustrate the degradation of a second memory cell according to an embodiment of the inventive concepts.

FIG. 5 illustrates a method for managing an address mapping table according to an exemplary embodiment of the inventive concepts.

FIGS. 6A and 6B illustrate a method for managing an address mapping table according to another exemplary embodiment of the inventive concepts.

FIG. 7 illustrates a method for managing an address mapping table according to another exemplary embodiment of the inventive concepts.

FIG. 8 illustrates a nonvolatile memory system according to another exemplary embodiment of the inventive concepts.

FIG. 9 illustrates a software hierarchy of a nonvolatile memory system.

FIGS. 10A and 10B are block diagrams illustrating a flash translation layer (FTL).

### DETAILED DESCRIPTION OF THE EMBODIMENTS

The advantages and features of the inventive concepts and methods of achieving them will be apparent from the following exemplary embodiments that will be described in more detail with reference to the accompanying drawings. It should be noted, however, that the inventive concepts are not limited to the following exemplary embodiments, and may be implemented in various forms. Accordingly, the exemplary embodiments are provided only to disclose examples the inventive concepts and to let those skilled in the art understand the nature of the inventive concepts.

In the drawings, embodiments of the inventive concept are not limited to the specific examples provided herein and are exaggerated for clarity. Furthermore, the same reference numerals denote the same elements throughout the specification.

As used herein, the term “and/or” includes any and all combinations of one or more of the associated listed items. It will be understood that when an element is referred to as being “connected” or “coupled” to another element, it may be directly connected or coupled to the other element or intervening elements may be present. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Hereinafter, embodiments of the inventive concepts will be described in detail with reference to the accompanying drawings.

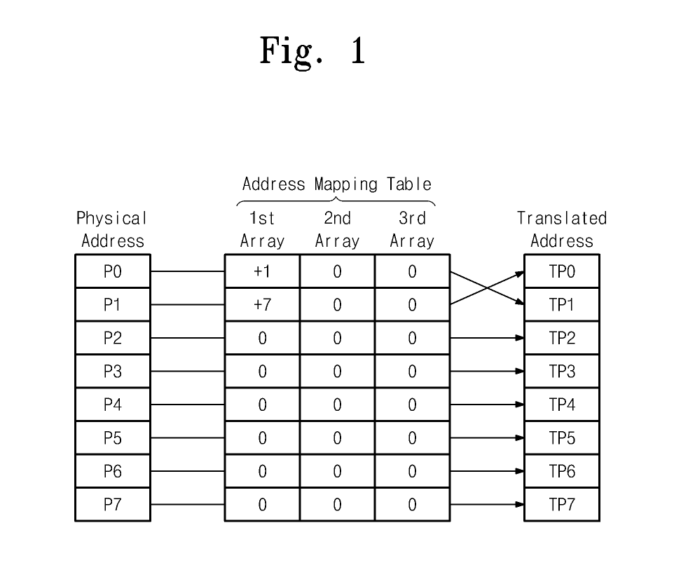

FIG. 1 illustrates a method for managing an address mapping table according to an exemplary embodiment of the inventive concepts.

In a nonvolatile memory device which internally adopts a wear-leveling scheme, an address provided to the nonvolatile memory device from a memory controller is defined as a physical address, and an address mapped with reference to a mapping table is defined as a translated physical address. The nonvolatile memory device internally manages a mapping table to map a provided physical address to a practically operating physical address. For example, the memory controller provides a command and an address to access the nonvolatile memory device. Since wear-leveling is internally carried out, the nonvolatile memory device maps (or translates) a physical address provided from the memory controller to an address of a practically operating memory cell with reference to an internal mapping table. In an exemplary embodiment described later, a method for managing a mapping table of a nonvolatile memory device internally carrying out a wear-leveling scheme will be described in detail.

FIG. 1 shows a procedure of mapping a physical address provided to a memory controller (not shown) to a practically operating physical address through a mapping table. The mapping table includes arrays that are allocated to addresses, respectively. For example, the mapping table may include a first array for storing a value varied when a physical address mapped relative to each provided physical address is translated first, a second array for storing a value varied when the mapped physical address is translated second, and a third array for storing a value varied when the mapped physical address is translated third. In the case that a mapping table includes an array, an address may be stored as much as a size of the array. Thus, the erase count number of a memory device storing the mapping table may decrease.

According to an exemplary embodiment of the inventive concepts, a difference in value between a pre-translated physical address and a physical address to be translated is stored in a mapping table. That is, an address shift amount is stored in a mapping table. The address shift amount indicates how much an address is shifted based on a pre-translated physical address, and the shift amount may be an increasing value or a decreasing value. In this embodiment, the shift amount may be an increasing value. A physical address and a translated physical address are mapped in one-to-one correspondence. In the initial stage, physical addresses and translated physical addresses are mapped to match each other. For example, a physical address 0 (P0) is mapped to a translated physical address 0 (TP0), a physical address 1 (P1) is mapped to a translated physical address 1 (TP1), and the other physical addresses (P2˜P7) and the other translated physical addresses (TP2˜TP7) are mapped in the same manner.

As shown in the example of FIG. 1, the physical address 0 (P0) where the translated physical address mapped to the physical address 0 (P0) is changed is mapped to a physical address 0 (TP0) in the initial stage. When a physical address mapped to the physical address 0 (P0) is changed into the translated physical address 1 (TP1), the shift amount of an address shifted to be based on the pre-changed translated physical address (TP0) is stored in the first array allocated to the physical address 0 (P0). Since the address mapped to the physical address 0 (P0) is shifted to the physical address 1 (TP1) changed from the translated physical address 0 (TP0), the shift amount of the address stored in the first array allocated to the physical address 0 (P0) is ‘1’. Therefore, when a memory control logic (not shown) maps a translated physical address to the physical address 0 (P0) with reference to a mapping table, a value ‘1’ obtained by adding the shift amount ‘1’ to an initial physical address value ‘0’ is the physical address mapped to the physical address 0 (P0).

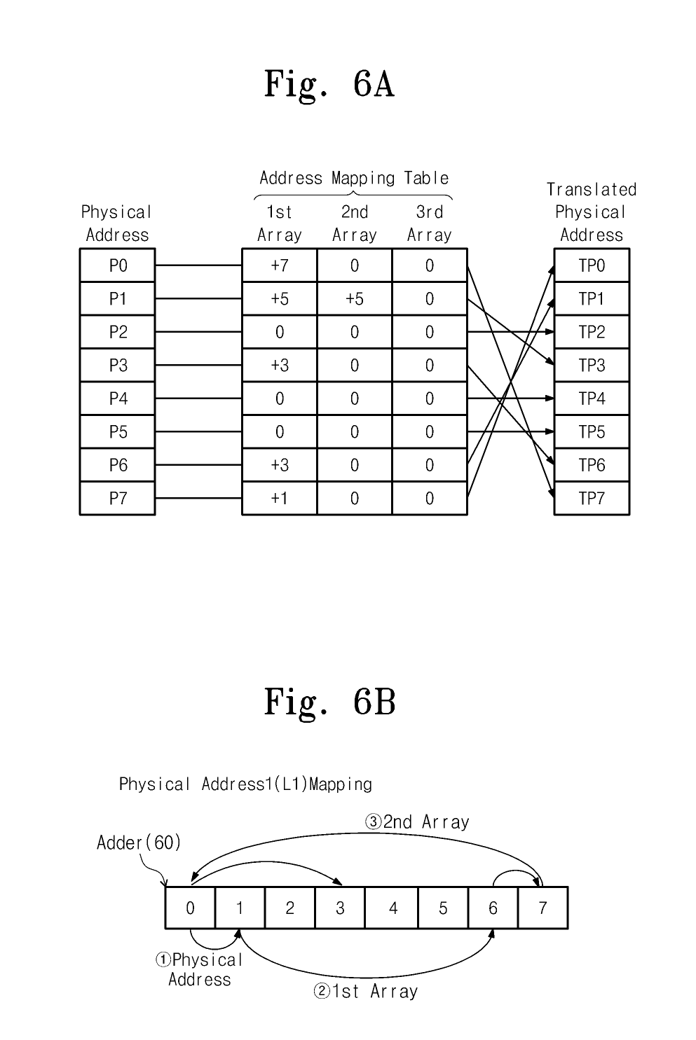

Since a physical address and a translated physical address are mapped in one-to-one correspondence, the translated physical address 0 (TP0) mapped to the physical address 0 (P0) is mapped to the physical address 1 (P1). That is, the physical address 1 (P1) is mapped to the translated physical address 0 (TP0). The shift amount of an address shifted to be based on the pre-changed translated physical address (TP1) is stored in the first array allocated to the physical address 1 (P1). According to an embodiment of the inventive concepts, a translated physical address mapped to a physical address is managed in a circular queue manner. Moreover, because the shift amount is not a decreasing value but an increasing value, the shift amount is ‘7’. Therefore, when a memory control logic (not shown) maps a translated physical address to the physical address 1 (P1) with reference to a mapping table, a value ‘8’ obtained by adding the shift amount ‘7’ to an initial physical address value ‘1’ is the physical address mapped to the physical address 1 (P1). Since the translated physical address is managed in a circular queue manner, the address mapped to the physical address 1 (P1) is a translated physical address 0 (TP0). A method for managing such a mapping table will be described later in detail with reference to FIGS. 6A and 6B.

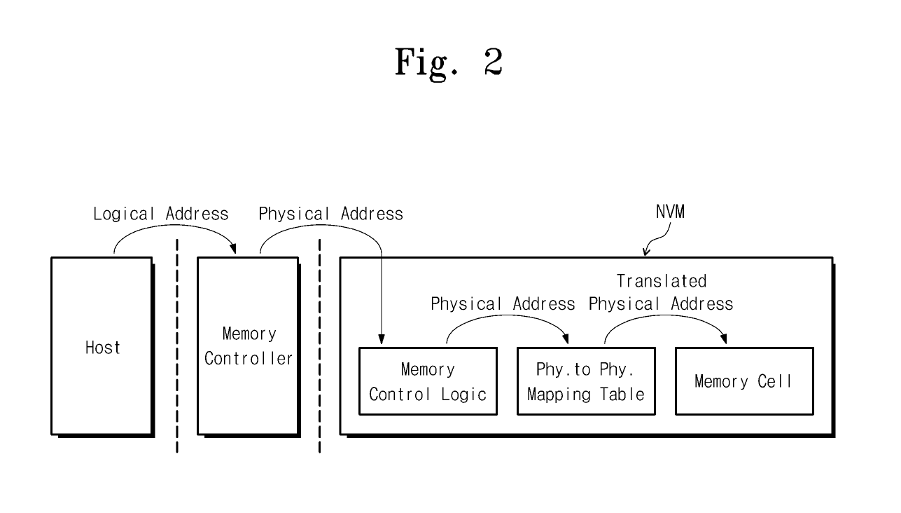

FIG. 2 illustrates the address translation of a nonvolatile memory device according to an embodiment of the inventive concept. More specifically, FIG. 2 illustrates the steps of translating an address for accessing a memory cell through a host, a memory controller, and a control logic.

As shown in FIG. 2, when accessing a nonvolatile memory device, a file system of a host provides a logical address to the memory controller. The memory controller maps (or translates) the logical address provided from the file system to a physical address. In this case, the memory controller may refer to a logical-to-physical address mapping table to map a logical address to a physical address. The memory controller provides the physical address to the nonvolatile memory device.

Still referring to FIG. 2, a nonvolatile memory device (NVM) internally employing a wear-leveling scheme maps a provided physical address to a practically operating physical address. That is, the memory control logic translates a physical address provided from the memory controller to a translated physical address. The memory control logic refers to a physical-to-physical address mapping table to map a physical address to a translated physical address.

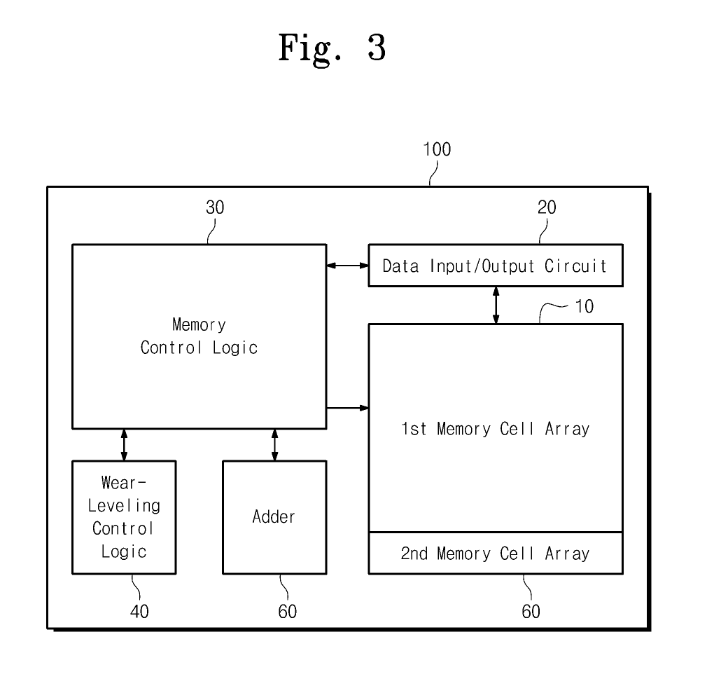

FIG. 3 is a block diagram of a nonvolatile memory device according to an embodiment of the inventive concepts. The nonvolatile memory device of this example includes flash memory. However, it will be understood that the nonvolatile memory device is not limited to flash memory. For example, the nonvolatile memory device may include other types of nonvolatile memory such as a phase-change RAM (PRAM), a ferroelectric RAM (FRAM), and a magnetic RAM (MRAM).

Referring to FIG. 3, a flash memory 100 includes a first memory cell array 10, a data input/output circuit 20, a memory control logic 30, a wear-leveling control logic 40, a second memory cell array 50, and an adder 60.

The first memory cell array 10 includes nonvolatile memory cells for storing data. Each of the memory cells may store single-bit data or multi-bit data. For example, the first memory cell array 10 may include flash memory cells including a floating gate or a charge storage layer such as a charge trap layer. The data input/output circuit 20 reads data stored in the first memory cell array 10 or stores data in the first memory cell array 10 in compliance with the control of the memory control logic 30.

The memory control logic 30 controls read, write, and erase operations of the flash memory 100 in response to a command, an address, and a control signal provided from a memory controller (not shown). According to an embodiment of the inventive concepts, the memory control logic 30 controls the wear-leveling control logic 40 such that the flash memory 100 performs wear-leveling internally. The memory control logic 30 manages a mapping table, based on wear-leveling information provide from the wear-leveling control logic 40. In addition, the memory control logic 30 maps an address provided from the memory controller to an address of a practically operating memory cell with reference to a mapping table. During the address mapping, the memory control logic 30 operates the mapped address by means of the adder 60.

The wear-leveling control logic 40 performs a wear-leveling operation of the flash memory 100 in compliance with the control of the memory control logic 30. When the wear-leveling operation is performed by the wear-leveling control logic 40, wear level information (e.g., mapping information) is provided to the memory control logic 30 to replace a high wear-level memory cell (or sector, block, etc.) with a low wear-level memory cell (or sector, block, etc.). The provided mapping information is constituted as a mapping table by the memory control logic 30. The mapping table is stored in the second memory cell 50. In the example of this embodiment, the wear-leveling control logic 40 is separated from a hardware standpoint from the memory control logic 30. That is, the wear-leveling control logic 40 includes an independent controller configured to perform the wear-leveling operation of the flash memory 100. However, the wear-leveling control logic 40 may instead be included in the memory control logic 30.

The second memory cell array 50 includes memory cells for storing a mapping table. Each of the memory cells may store single-bit data or multi-bit data. According to an embodiment of the inventive concepts, the second memory cell array 50 may be isolated from the first memory cell array 10. However, it will be understood that the second memory cell array 50 may be a region of the first memory cell array 10. Since the second memory cell array 50 is not a region for storing data provided from a memory controller, it is managed as a hidden region. The data input/output circuit 20 reads data stored in the second memory cell array 50 or stores data in the second memory cell array 50 in compliance with the control of the memory control logic 30. On the other hand, the flash memory 100 may include another data input/output circuit for reading data stored in the second memory cell array 50 and/or storing data in the second memory cell array 50.

The second memory cell array 50 includes nonvolatile memory cells to store a mapping table even when the supply of power is interrupted. For example, the second memory cell array 50 may include flash memory cells including a floating gate or a charge storage layer such as a charge trap layer. In the case where the second memory cell array 50 includes flash memory cells, an erase operation is performed in well-sharing units (e.g., in units of block) due to the structural characteristic of the second memory cell array 50. Moreover, an erase operation must be performed in advance when a write operation is re-performed (i.e., an overwrite operation) for a memory cell in which data is stored. As the number of performing a wear-leveling operation increases, a mapping table is frequently updated to degrade memory cells included in the second memory cell array 50. Thus, the mapping table is preferably managed to avoid frequent updating.

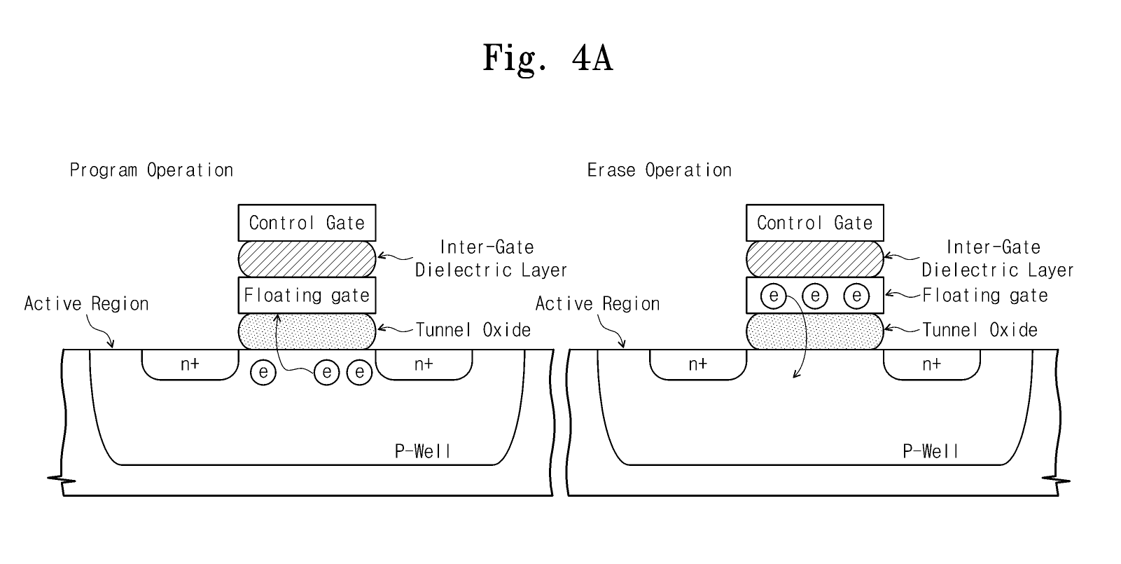

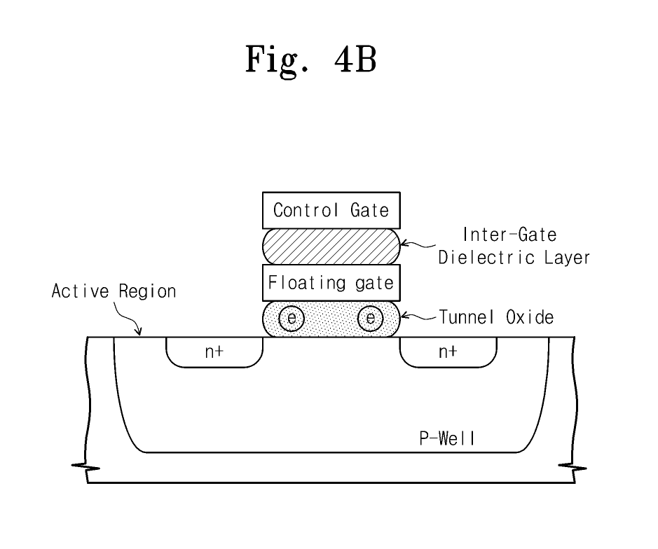

FIGS. 4A and 4B illustrate the degradation of a second memory cell according to an embodiment of the inventive concepts.

Referring to FIGS. 4A and 4B, a charge storage layer included in a second memory array 50 includes a floating gate. For example, a tunnel oxide layer formed on an active region, a floating gate in which data is stored, an inter-gate dielectric layer, and a control gate controlling the floating gate may be stacked as shown.

When a write operation is performed, electrons are stored in the floating gate by hot electron injection or an FN (Fowler-Nordheim) tunneling mechanism. When an erase operation is performed, electrons are ejected through the tunnel oxide layer. When write and erase operations are performed, electrons migrate through the tunnel oxide layer. When write and erase operations are frequently performed, a tunnel oxide layer of a memory cell is rapidly degraded. For example, as shown in FIG. 4B, electrons may be trapped to the tunnel oxide layer. If the tunnel oxide layer is degraded, characteristics of a memory cell included in the second memory array 50 may be deteriorated to cause a loss of a mapping table data stored in the second memory array 50. A memory control logic 30 according to an embodiment of the inventive concepts manages a mapping table to prevent or reduce degradation of memory cells of the second memory array 50.

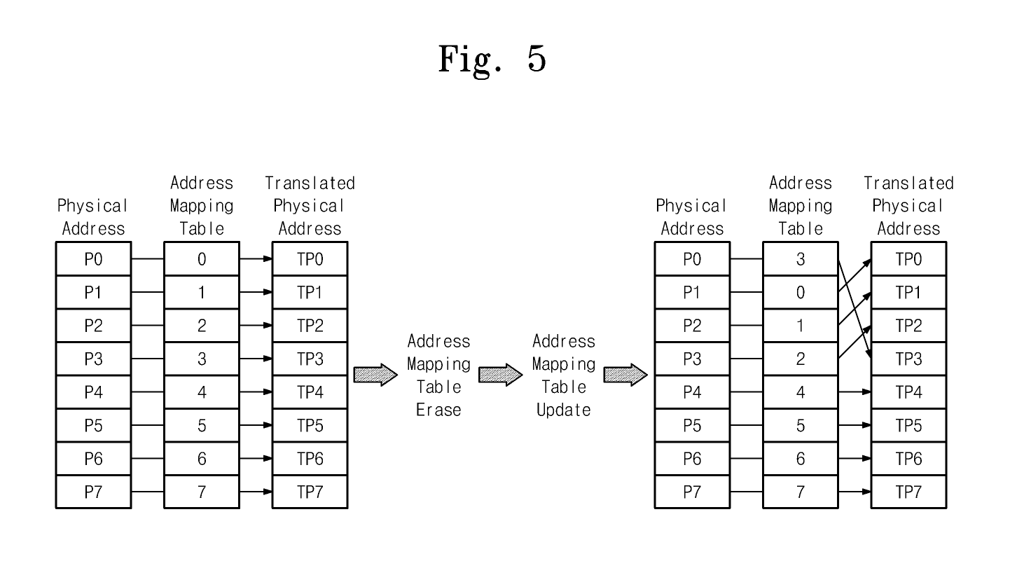

FIG. 5 illustrates a method for managing an address mapping table according to an exemplary embodiment of the inventive concepts.

FIG. 5 showed eight physical addresses P0˜P7, translated physical addresses TP0˜TP7 respectively mapped to physical addresses, and a mapping table mapping physical addresses and translated physical addresses. Physical addresses and translated physical addresses are set to be mapped in one-to-one correspondence. In the initial stage, physical addresses and translated physical addresses are mapped to match each other. That is, a physical address 0 (P0) is mapped to a translated physical address 0 (TP0), a physical address 1 (P1) is mapped to a translated physical address 1 (TP1), and the other physical addresses (P2˜P7) and the other translated physical addresses (TP2˜TP7) are mapped in the same manner. Accordingly, physical addresses and translated physical addresses are stored in the mapping table.

For the brevity of description, there is provided an example in which translated physical addresses mapped to a physical address 0 (P0) to a physical address 3 (P3) are changed. If even one of the physical addresses P0˜P3 is changed into a mapped translated physical address, the mapping table may be stored in a temporary storage region (e.g., a register or a first memory region). After the mapping table is temporarily stored, a second memory cell array 50 storing the mapping table is erased in compliance with the control of the memory control logic 30. Further, the temporarily stored mapping table is updated by the memory control logic 30. For example, a region allocated to the physical address 0 (P0) of the mapping table is updated into a translated physical address ‘3’, a region allocated to the physical address 1 (P1) of the mapping table is updated into a translated physical address ‘0’, a region allocated to the physical address 2 (P2) of the mapping table is updated into a translated physical address ‘1’, and a region allocated to the physical address 3 (P3) of the mapping table is updated into a translated physical address ‘2’. The updated mapping table is re-stored in the second memory cell array 50. In other words, if even one of the physical addresses is changed into a mapped translated physical address, the second memory cell array 50 stored in the mapping table entails erase and write operations.

FIGS. 6A and 6B illustrate a method for managing an address mapping table according to another exemplary embodiment of the inventive concepts.

Referring to FIG. 6A, for the brevity of description, eight physical addresses P0˜P7 and translated physical addresses TP0˜TP7 each being mapped to a physical address will now be described in detail as an example. The mapping table includes arrays that are allocated to physical addresses, respectively. For example, the mapping table may include a first array for storing a value varied when a physical address mapped relative to each provided physical address is translated first, a second array for storing a value varied when the mapped translated physical address is translated second, and a third array for storing a value varied when the mapped translated physical address is translated third.

According to an embodiment of the inventive concepts, when a translated physical address mapped to any physical address is changed, an address shift amount is stored in a mapping table. The address shift amount indicates how much an address is shifted based on a pre-translated physical address. Physical addresses and translated physical addresses are mapped in one-to-one correspondence. In the initial stage, physical addresses and translated physical addresses are mapped to match each other. The translated physical address mapped to the physical address is managed in a circular queue manner.

When a translated physical address mapped to a physical address 0 (P0) is changed into a translated physical address 7 (TP7), the shift amount ‘7’ of an address to be shifted based on a pre-changed translated physical address (TP0) is stored in a first array allocated to the physical address 0 (P0). Since a physical address and a translated physical address are mapped in one-to-one correspondence, the translated physical address 0 (TP0) mapped to the physical address 0 (P0) is mapped to the physical address 7 (TP7). A translated physical address mapped to a physical address is managed in a circular queue manner, and the address shift amount is not a decreasing value but an increasing value. Therefore, the shift amount ‘1’ of an address to be shifted based on the pre-changed translated physical address (TP7) is stored in a first array allocated to the physical address 7 (P7).

When a translated physical address mapped to a physical address 1 (P1) is changed into a translated physical address 6 (TP6), the shift amount ‘5’ of an address to be shifted based on a pre-changed translated physical address (TP1) is stored in a first array allocated to the physical address 1 (P1). In this case, since there are arrays respectively allocated to physical addresses, an erase operation is not performed at a memory region in which a mapping table is stored. Since a physical address and a translated physical address are mapped in one-to-one correspondence, the translated physical address 1 (TP1) mapped to the physical address 1 (P1) is mapped to the physical address 6 (TP6). Therefore, the shift amount ‘3’ of an address to be shifted based on the pre-changed translated physical address (TP6) is stored in a first array allocated to the physical address 6 (P6).

When a translated physical address mapped to a physical address 1 (P1) is re-changed into a translated physical address 3 (TP3), the shift amount ‘5’ of an address to be shifted based on the pre-changed translated physical address (TP6) is stored in a second array allocated to the physical address 1 (P1). In this case, it will be understood that because the translated physical address is changed second, the changed address is stored in the second array. Since a physical address and a translated physical address are mapped in one-to-one correspondence, the translated physical address 6 (TP6) mapped to the physical address 1 (P1) is mapped to the physical address 3 (TP3). Therefore, the shift amount ‘3’ of an address to be shifted based on the pre-changed translated physical address (TP3) is stored in a first array allocated to the physical address 3 (P3).

Referring to FIG. 6B, a method for mapping a physical address to a translated physical address by a memory control logic (30 in FIG. 2) will now be described in detail. For the brevity of description, an example of mapping a physical address 1 (P1) will be described. The memory control logic (30 in FIG. 2) refers to a mapping table during a mapping operation and controls an adder 60 to perform the mapping operation. During an addition operation, the adder 60 is initialized when overflow occurs. Thus, the adder 60 is configured to re-perform a remaining addition operation. In addition, during the mapping operation, the memory control logic (30 in FIG. 2) maps a physical address to a translated physical address according to the below Equation 1.

Translated Physical Address=Physical Address(or Initial Translated Physical Address Mapped to Physical Address)+ΣAddress Shift Amount Equation 1

An address value of a physical address 1 (P1) required to be mapped is ‘1’. Therefore, the adder 60 is controlled to perform an addition operation of adding ‘1’. Since shift amount ‘5’ is stored in a first array allocated to the physical address 1 (P1), the adder 60 is controlled to perform an addition operation of adding ‘5’. The shift amount ‘5’ is stored in a second array allocated to the physical address 1 (P1). Similarly, the adder 60 is controlled to perform an addition operation of adding ‘5’. Since overflow occurs during an addition operation, the adder 60 is initialized to perform a remaining addition operation. A result value of the adder 60 is ‘3’, and the memory control logic (30 in FIG. 2) maps a translated physical address 3 (TP3) to the physical address 1 (TP1).

According to an embodiment of the inventive concepts, when a translated physical address mapped to a physical address is changed, the address shift amount of the translated physical address is stored in an array of a mapping table allocated to a corresponding physical address. During a mapping operation, a translated physical address is mapped to a corresponding physical address by an operation of adding an address shift amount. Therefore, it is not necessary for the memory control logic (30 in FIG. 2) to scan what is final mapping data among data stored in the mapping table. When the translated physical address mapped to the physical address is changed, the address shift amounts are sequentially stored in mapping table arrays respectively allocated to physical addresses to decrease an erase operation of a memory region in which the mapping table is stored.

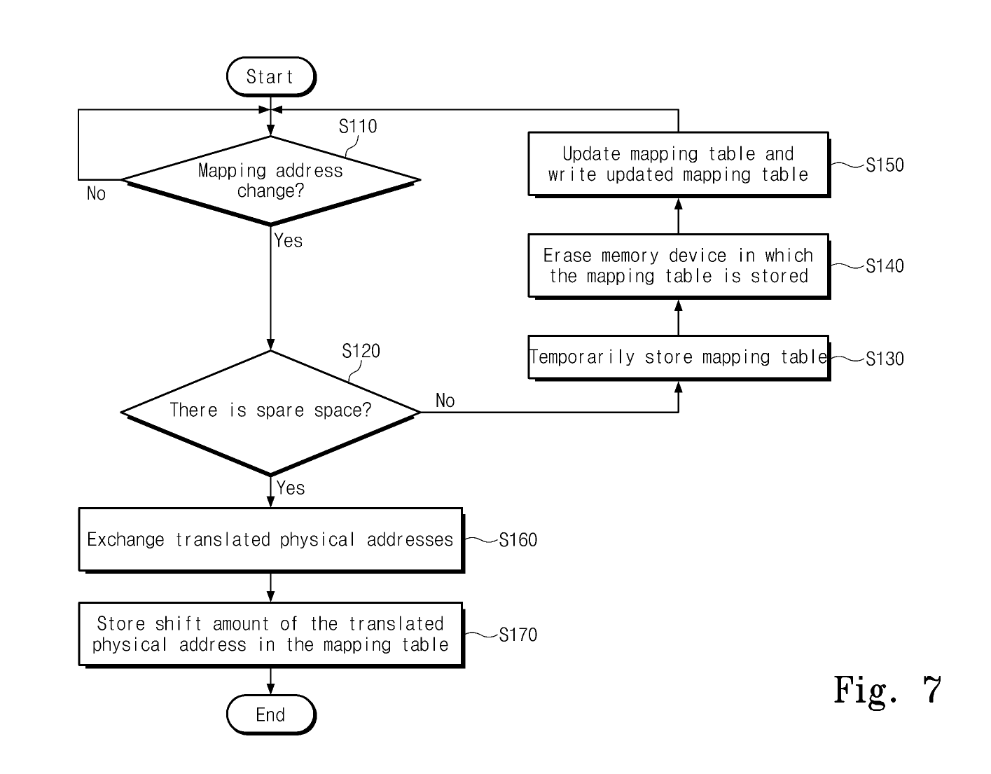

FIG. 7 illustrates a method for managing an address mapping table according to another exemplary embodiment of the inventive concepts.

Referring to FIGS. 3 and 7, the memory control logic 30 determines whether a translated physical address mapped to a physical address is changed based on wear-level information provided from the wear-leveling control logic 40 (S110). When the translated physical address mapped to a physical address is changed, the memory control logic 30 determines whether a spare space to store updated mapping information exists in a mapping table of a physical address where the mapping information is changed (S120). If the spare space does not exist, the memory control logic 30 temporarily stores the mapping table after copying the mapping table to a temporary storage region (e.g., a register, a latch, a first memory or the like of a nonvolatile memory device) (S130). After temporarily storing the mapping table, the memory control logic 30 erases a second memory array 60 in which the mapping table is stored (S140). The memory control logic 30 updates mapping information and stores the updated mapping information in the second memory array 60 (S150).

If the spare space to store the updated mapping information exists, the memory control logic 30 exchanges a translated physical address originally mapped to physical address pairs where the mapping information is to be changed (S160). The memory control logic 30 stores the address shift amount in mapping tables of the respective physical address pairs to be changed (S170). As previously stated, the address shift amount indicates how much an address is shifted based on a pre-translated physical address.

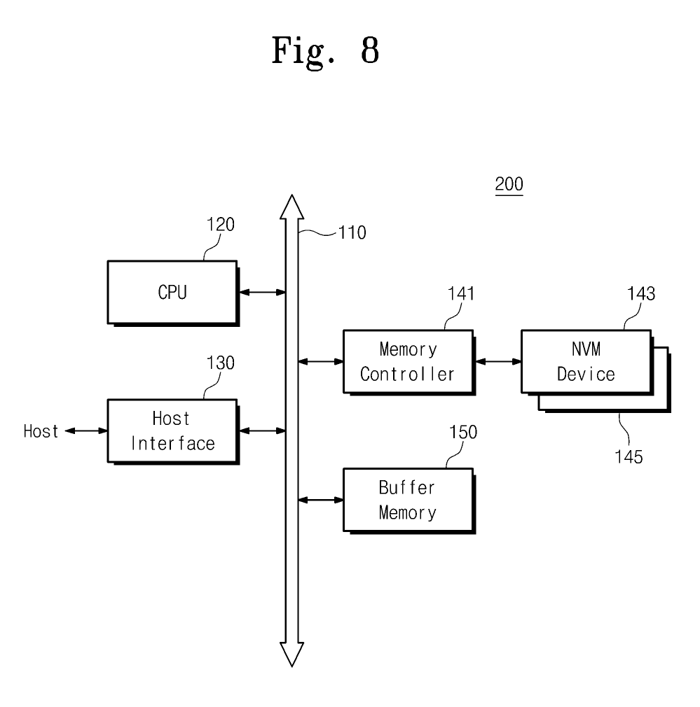

FIG. 8 illustrates a nonvolatile memory system according to another exemplary embodiment of the inventive concept.

In a memory system using a nonvolatile memory device as a storage medium, a host system generally accesses the nonvolatile memory device via a file system and a memory controller to manage data of the memory system. When the file system accesses the nonvolatile memory device, it provides a logical address to the memory controller. The memory controller maps (or translates) the logical address to a physical address of the nonvolatile memory device. The memory controller refers to an address mapping table (herein referred to as “mapping table”) to map a logical address to a physical address.

Referring to FIG. 8, a nonvolatile memory system 200 includes a system bus 110, a central processing unit (CPU) 120, a host interface 130, a memory controller 141, nonvolatile memory devices 143 and 145, and a buffer memory 150.

The nonvolatile memory device 143 may be configured using a flash memory. However, it will be understood that the nonvolatile memory device 143 is not limited to flash memory. For example, the nonvolatile memory device 143 may instead be configured using other types of nonvolatile devices such as a phase-change RAM (PRAM), a ferroelectric RAM (FRAM), and a magnetic RAM (MRAM). Further, the nonvolatile memory system 200 may include a plurality of the same or different types of nonvolatile memory devices.

The system bus 110 is a path along which data is transferred between elements of the nonvolatile memory system 200. The host interface 130 may include a protocol for data exchange between a host and the CPU 120. The CPU 120 controls the nonvolatile memory system 200 to execute a command (e.g., reading or writing of data) requested from a host system. Generally, the CPU 120 temporarily stores firmware in the buffer memory 150 to control the nonvolatile memory system 200 and executes the stored firmware to perform a series of read and write operations for the flash memory 143. The memory controller 141 directly controls the flash memory 143 according to the read or write sector of the CPU 120.

The CPU 120 stores a mapping table in the flash memory 143. The CPU 120 loads the stored mapping table to the buffer memory 150 and refers to the loaded mapping table during a mapping operation. When the mapping table is updated, the CPU 120 updates the temporarily stored mapping table in the buffer memory 150. According to an embodiment of the inventive concepts, the CPU 120 stores an address shift amount in the mapping table. As previously stated, the address shift amount indicates how much an address is shifted based on a pre-translated physical address. During the mapping operation, the CPU 120 maps a physical address to a corresponding logical address by adding the stored shift amount. When power supply is interrupted, the CPU 120 stores the temporarily stored mapping table in the flash memory 143.

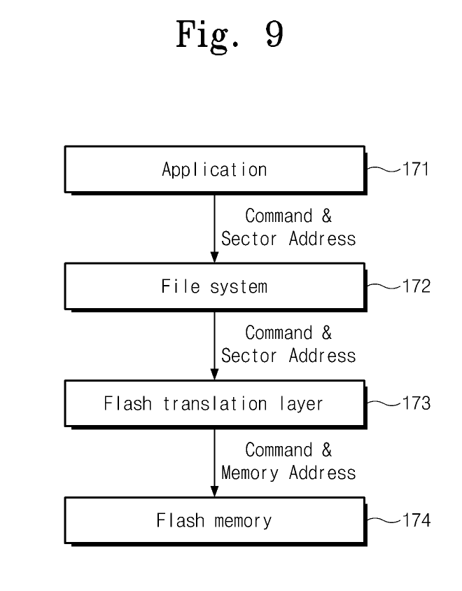

FIG. 9 illustrates a software hierarchy of a nonvolatile memory system.

Referring to FIG. 9, a host system has a software layer including an application 171 and a file system 172, and a nonvolatile memory device 200 has a software layer including a flash translation layer (FTL) 173 and a hardware layer including a flash memory 174.

The file system 172 receiving a read or write sector from the application 171 transfers a command and a sector address, which are read or write targets, to the FTL 173. The FTL 173 transfers the received command to the flash memory 174. Also, the FTL transfers the received sector address to the flash memory 174 after translating the sector address into a memory address of the flash memory 174. The sector address is a logical address, and the memory address of the flash memory 174 is a physical address.

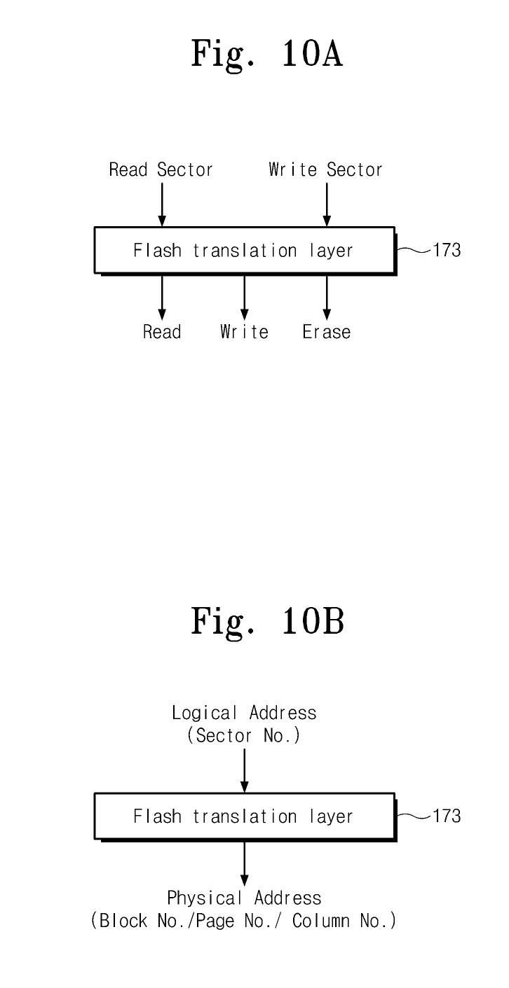

FIGS. 10A and 10B are block diagrams illustrating a flash translation layer (FTL).

Referring to FIGS. 8 and 10A, since a flash memory 174 cannot execute a data overwrite operation, an erase operation must be performed in advance to rewrite data into the flash memory 174 in which data is stored. Moreover, since the flash memory 174 is characterized in that an erase unit is greater than a write unit, a flash translation layer (FTL) 173 is utilized between a file system 172 and the flash memory 174 to control the flash memory 174.

When a read or write sector for any sector address is received from the file system 172 that is an upper layer, the FTL 173 serves to translate the read or write sector into a command to be provided to the flash memory 174. That is, the FTL 173 translates a command such that the flash memory 174 performs a read, write or erase operation. Moreover, the FTL 173 manages a bad block of the flash memory 174 and a wear level of each block.

Referring to FIG. 10B, the FTL 173 serves to map a logical address transferred from an upper layer to a physical address of a flash memory. That is, the FTL 173 translates a sector number, which is a logical address on a virtual disk, to a block number, a page number or a column number. The FTL 173 manages a mapping table to carry out such an address translation.

A nonvolatile memory system according to another embodiment of the inventive concepts employs the above-described method for managing an address mapping table. A central processing unit (e.g., 120 in FIG. 8) includes arrays that are allocated to logical addresses, respectively. When a physical address mapped to any logical address is translated, an address shift amount is stored in a mapping table. As previously stated, the address shift amount indicates how much an address is shifted based on a pre-translated physical address. During a mapping operation, the central processing unit adds the stored shift amounts to a mapping table of a logical address required to be mapped (or an initial physical address mapped to a logical address) and a corresponding logical address to calculate a mapped physical address with reference to the mapping table.

As explained above, an address mapping table is managed to decrease the number of erase counts of a memory device in which the address mapping table is stored. Thus, a lifetime of the memory device can be extended and the performance thereof can be enhanced.

While the inventive concepts have been described with reference to exemplary embodiments, it will be apparent to those skilled in the art that various changes and modifications may be made without departing from the spirit and scope of the inventive concept. Therefore, it should be understood that the above embodiments are not limiting, but illustrative. Thus, the scope of the inventive concepts is to be determined by the broadest permissible interpretation of the following claims and their equivalents, and shall not be restricted or limited by the foregoing description.

What is claimed is:

1. A method for managing an address mapping table of a nonvolatile memory device, comprising:
(a) determining when a translated physical address mapped to a physical address has changed;
(b) when the translated physical address mapped to the physical address has been determined to change, storing a shift amount of an address to be shifted based on a pre-changed translated physical address mapped to the physical address in the address mapping table; and
(c) mapping the changed translated physical address to the physical address.

2. The method as set forth in claim 1, wherein the step (a) is executed according to a wear-leveling scheme.

3. The method as set forth in claim 1, wherein the step (b) comprises:
determining whether a spare space to store the changed translated physical address exists in the mapping table, and
storing the shift amount in the mapping table when the spare space is determined to exist in the mapping table.

4. The method as set forth in claim 3, wherein, when the spare space does not exist in the mapping table, further comprising:
temporarily storing the mapping table;
erasing a storage region in which the mapping table is stored;
updating the mapping table; and
storing the updated mapping table in the erased storage region.

5. The method as set forth in claim 1, wherein the shift amount is an increasing value.

6. The method as set forth in claim 5, wherein the translated physical address is managed in a circular queue manner, and
when the pre-changed translated physical address is greater than the changed translated physical address, the shift amount is determined by a value obtained by adding a value between the last address of the translated physical address and the changed translated physical address and a value between the changed translated physical address and a start address of the translated physical address.

7. The method as set forth in claim 1, wherein the mapping table comprises an array.

8. The method as set forth in claim 7, wherein the shift amount is sequentially stored in the array.

9. The method as set forth in claim 1, wherein a translated physical address is mapped to a physical address according to a result value obtained by adding a translated physical address mapped first to the physical address and the shift amount stored in the mapping table.

10. The method as set forth in claim 9, wherein the translated physical address mapped first to a physical address is identical to the physical address.

11. The method as set forth in claim 9, wherein the translated physical address is managed in a circular queue manner, and
the changed translated physical address is mapped after being further shifted from a start address of the translated physical address by a remaining shift amount when the result value is greater than the last address of the translated physical address.

12. A memory device comprising:
a first memory cell array configured to store data;
a wear-leveling control logic configured to manage a wear level operation;
a second memory cell array configured to store an address mapping table; and
a memory control logic configured to store a shift amount of an address to be shifted based on a pre-changed translated physical address mapped to a physical address in the address mapping table when a translated physical address mapped to a physical address of the first memory cell array is changed, and configured to map the physical address to the changed translated physical address with reference to the address mapping table.

13. The memory device as set forth in claim 12, wherein the wear-leveling control logic manages a wear level of the first memory cell array.

14. The memory device as set forth in claim 12, wherein the translated physical address mapped to the physical address is changed according to wear-level information provided from the wear-leveling control logic.

15. The memory device as set forth in claim 12, further comprising an adder configured to add a translated physical address mapped first to the physical address and the shift amount stored in the mapping table in compliance with the control of the memory control logic.

16. The memory device as set forth in claim 15, wherein the adder is initialized to continue to perform a remaining addition operation when an overflow occurs during an addition operation.

17. The memory device as set forth in claim 12, wherein
the first and second memory cell arrays comprise memory cell transistors each including a floating gate, and
the memory cell transistors are independently connected to a bitline and a wordline.

18. The memory device as set forth in claim 12, wherein the memory control logic manages the second memory cell array as a hidden region.

19. The memory device as set forth in claim 12, further comprising at least one data input/output circuit configured to read data stored in the first and second memory cell arrays and to store data in the first and second memory cell arrays.

20. The memory device as set forth in claim 12, further comprising:
a first data input/output circuit configured to read data stored in the first memory cell array and to store data in the first memory cell array; and
a second data input/output circuit configured to store read data stored in the second memory cell array and to store data in the second memory cell array.
